(19) United States
(12) Patent Application Publication
(10) Pub. No.: US 2024/0401998 A1
(43) Pub. Date: Dec. 5, 2024

(54) WEIGHT CALCULATION DEVICE

(71) Applicants: TOYOTA JIDOSHA KABUSHIKI KAISHA, Toyota-shi (JP); ADVICS CO., LTD., Kariya-shi Aichi-ken (JP)

(72) Inventors: Kazuki MIYAKE, Okazaki-shi (JP); Takaya UCHIDA, Tokyo (JP); Naoki TAGAMI, Tokyo (JP)

(73) Assignees: TOYOTA JIDOSHA KABUSHIKI KAISHA, Toyota-shi (JP); ADVICS CO., LTD., Kariya-shi Aichi-ken (JP)

(21) Appl. No.: 18/669,822

(22) Filed: May 21, 2024

(30) Foreign Application Priority Data
May 30, 2023 (JP) 2023-088457

(51) Int. Cl. G01G 19/08

(52) U.S. Cl. CPC G01G 19/086

(57) ABSTRACT

A weight calculation device includes one or more processors and one or more memories. The one or more memories are configured to store a plurality of specific speed ranges in advance, the specific speed ranges being obtained by dividing a travel speed of a vehicle into a plurality of speed ranges. The one or more processors are configured to: acquire the travel speed of the vehicle, an acceleration of the vehicle, and a driving force of the vehicle while the vehicle is traveling; store a combination of the acquired acceleration of the vehicle and the acquired driving force of the vehicle in the one or more memories in a distinguishable manner for each of the specific speed ranges; and calculate a weight of the vehicle for each of the specific speed ranges based on a plurality of the combinations of the acquired acceleration and the acquired driving force.

### CROSS-REFERENCE TO RELATED APPLICATION

This application claims priority to Japanese Patent Application No. 2023-088457 filed on May 30, 2023, incorporated herein by reference in its entirety.

### BACKGROUND

### 1. Technical Field

The present invention relates to weight calculation devices.

### 2. Description of Related Art

A vehicle control system disclosed in Japanese Unexamined Patent Application Publication No. 2020-032894 (JP 2020-032894 A) includes a plurality of execution units, a motion manager, and actuators. The execution units execute individual applications. The motion manager receives motion requests from a plurality of applications. The motion manager generates instruction values for the actuators based on the received motion requests.

### SUMMARY

In such a technique as that of Japanese Unexamined Patent Application Publication No. 2020-032894 (JP 2020-032894 A), the motion manager may consider the weight of the vehicle when generating instruction values for the actuators. In this case, the motion manager needs to calculate the weight of the vehicle including the weight of the load. The weight of the vehicle can be calculated based on the acceleration of the vehicle, the driving force of the vehicle, and the running resistance of the vehicle. The running resistance of the vehicle can be calculated based on the uniform correspondence that is present between the running resistance and the travel speed of the vehicle. However, this correspondence may change depending on the weight of the vehicle. If the running resistance of the vehicle and the weight of the vehicle are calculated without considering this point, it will be difficult to calculate the weight of the vehicle.

An aspect of the present disclosure provides a weight calculation device. This weight calculation device includes one or more processors; and one or more memories. The one or more memories are configured to store a plurality of specific speed ranges in advance, the specific speed ranges being obtained by dividing a travel speed of a vehicle into a plurality of speed ranges. The one or more processors are configured to: acquire the travel speed of the vehicle, an acceleration of the vehicle, and a driving force of the vehicle while the vehicle is traveling; store a combination of the acquired acceleration of the vehicle and the acquired driving force of the vehicle in the one or more memories in a distinguishable manner for each of the specific speed ranges; and calculate a weight of the vehicle for each of the specific speed ranges based on a plurality of the combinations of the acquired acceleration of the vehicle and the acquired driving force of the vehicle.

With the above configuration, the weight of the vehicle can be accurately calculated.

### BRIEF DESCRIPTION OF THE DRAWINGS

Features, advantages, and technical and industrial significance of exemplary embodiments of the invention will be described below with reference to the accompanying drawings, in which like signs denote like elements, and wherein:

FIG. 1 is a schematic configuration diagram of a vehicle;

FIG. 2 is a graph illustrating the principle of calculating the weight of the vehicle;

FIG. 3 is a schematic diagram showing how the weight of the vehicle is calculated for each specific speed range;

FIG. 4 is a graph illustrating the difference in running resistance depending on the weight of the vehicle;

FIG. 5 is a flowchart representing the steps of a weight calculation process; and

FIG. 6 is a graph illustrating functions of an embodiment.

### DETAILED DESCRIPTION OF EMBODIMENTS

### Overall Configuration of Vehicle

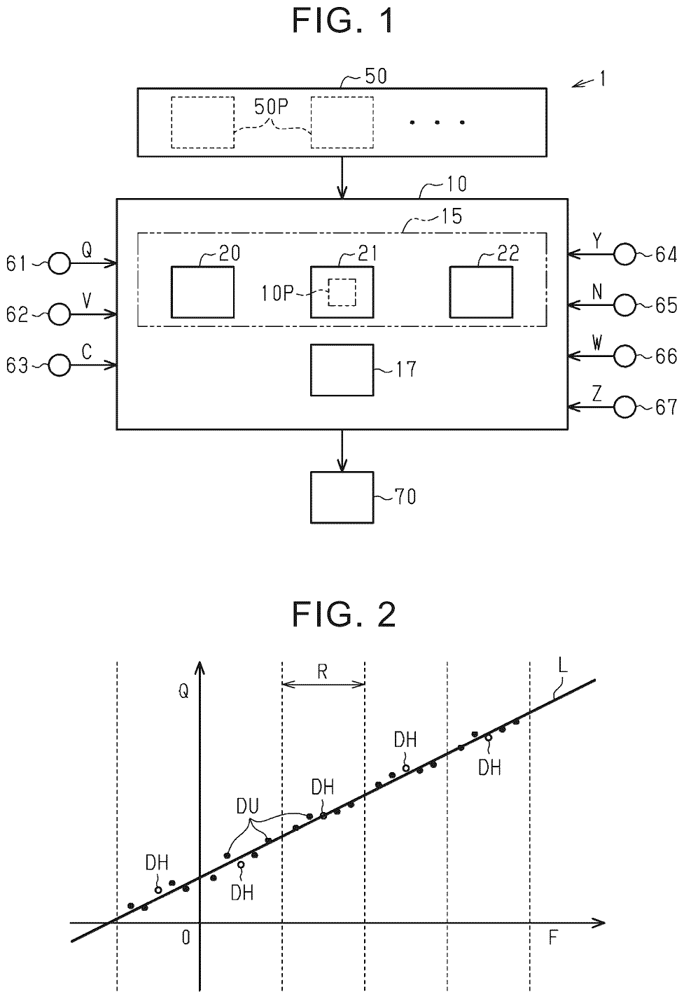

Hereinafter, an embodiment of a weight calculation device will be described with reference to the drawings. As shown in FIG. 1, a vehicle 1 includes an execution electronic control unit (ECU) 50, an integrated ECU 10, and a plurality of actuator units 70. FIG. 1 representatively shows one of the actuator units 70. An example of the actuator units 70 is a powertrain. The powertrain includes an internal combustion engine that serves as a driving source for the vehicle 1, and a transmission mechanism that transmits the torque of the internal combustion engine to drive wheels. In the internal combustion engine, a crankshaft rotates as a result of combustion of intake air with fuel. The transmission mechanism includes an automatic transmission that changes the rotational speed of the crankshaft and outputs the resultant rotation, and a differential gear that allows a difference in rotational speed between the right and left drive wheels. Other examples of the actuator units 70 include a brake device that generates a braking force on the vehicle 1, and a steering system that adjusts the steering angle of steered wheels of the vehicle 1.

The execution ECU 50 is a computer including a processing circuit. The processing circuit includes a central processing unit (CPU), a nonvolatile memory, and a volatile memory. The nonvolatile memory stores in advance various programs describing processes to be executed by the CPU and various types of data required for the CPU to execute the programs. Examples of the programs stored in the nonvolatile memory include a plurality of applications 50P for controlling the motion of the vehicle 1. The execution ECU 50 executes these applications 50P to output motion requests for the executed applications 50P. An example of the applications 50P is an application that implements a function to automatically follow the preceding vehicle.

The integrated ECU 10 is a computer including a processing circuit 15. The processing circuit 15 includes a CPU 20, a nonvolatile first memory 21, and a volatile second memory 22. The first memory 21 stores in advance various programs 10P describing processes to be executed by the CPU 20 and various types of data required for the CPU 20 to execute the programs 10P. The integrated ECU 10 includes a real-time clock 17. The real-time clock 17 is a circuit that generates date and time information. The integrated ECU 10 is a weight calculation device. The CPU 20 is a calculation unit. The first memory 21 is a storage unit.

The CPU 20 of the integrated ECU 10 functions as a motion manager that manages the motion of the vehicle 1 by executing the programs 10P stored in the first memory 21. As functions of this motion manager, the CPU 20 calculates the weight M of the vehicle 1, and controls each actuator unit 70 based on the calculated weight M and the motion requests from the execution ECU 50.

The vehicle 1 includes a plurality of sensors and a plurality of switches. For example, the vehicle 1 includes an acceleration sensor 61. The acceleration sensor 61 detects an acceleration Q of the vehicle 1. In the present embodiment, as shown by Expression (1) below, the sum of an acceleration A in the longitudinal direction of the vehicle 1 associated with travel of the vehicle 1 and a component of the gravitational accelerator g in the longitudinal direction of the vehicle 1 is treated as the acceleration Q of the vehicle 1. The acceleration sensor 61 of the present embodiment detects a positive value when the vehicle 1 accelerates forward in the longitudinal direction of the vehicle 1, and detects a negative value when the vehicle 1 accelerates rearward in the longitudinal direction of the vehicle 1. For the component of the gravitational acceleration g in the longitudinal direction of the vehicle 1, the acceleration sensor 61 detects a positive value on an uphill road and a negative value on a downhill road. In Expression (1), 0 is the slope of the road surface.

$$Q = A + g \times sin θ \qquad ( 1 )$$

The vehicle 1 includes a speed sensor 62. The speed sensor 62 detects a vehicle speed V that is a travel speed of the vehicle 1. The vehicle 1 includes an accelerator sensor 63. The accelerator sensor 63 detects an accelerator operation amount C that is an operation amount of an accelerator pedal of the vehicle 1. The vehicle 1 includes an air flow meter 64. The air flow meter 64 detects an intake air amount Y of the internal combustion engine. The vehicle 1 includes a crank sensor 65. The crank sensor 65 acquires a rotational position N of the crankshaft. Each sensor mounted on the vehicle 1 outputs a signal according to the information detected by the sensor itself to the integrated ECU 10. The vehicle 1 includes a courtesy switch 66. The courtesy switch 66 detects an open or closed state W of a door of the vehicle 1. The courtesy switch 66 outputs a signal according to the open or closed state W of the door to the integrated ECU 10. The courtesy switch 66 is provided for each door of the vehicle 1. The vehicle 1 includes a start switch 67. The start switch 67 is also called an ignition switch or a system start switch. The start switch 67 is turned on or off according to an occupant's operation. The start switch 67 outputs on-off information Z according to an occupant's operation to the integrated ECU 10. The integrated ECU 10 repeatedly receives signals from the sensors and switches described above.

### Principle of Calculating Vehicle Weight

Calculation of the weight M of the vehicle 1 by the CPU 20 of the integrated ECU 10 will be described in detail.

First, the principle of estimating the weight M of the vehicle 1 will be described. As shown by Expression (2) below, the acceleration Q of the vehicle 1, the weight M of the vehicle 1, and the propulsive force F of the vehicle 1 have the following relationship. The acceleration Q of the vehicle 1 is equal to the product of the reciprocal of the weight M of the vehicle 1 and the propulsive force F of the vehicle 1.

$$Q = ( 1 / M ) \times F \qquad ( 2 )$$

As shown by Expression (3) below, the propulsive force F of the vehicle 1 is a value obtained by subtracting an air resistance Fa acting on the vehicle 1 and a road surface resistance Fr acting on the vehicle 1 from a driving force Fd of the vehicle 1. The air resistance Fa is basically proportional to the square of the vehicle speed V. The road surface resistance Fr is defined as a constant. Hereinafter, the sum of the air resistance Fa and the road surface resistance Fr will be referred to as “running resistance Fx.”

$$F = Fd - Fa - Fr \qquad ( 3 )$$

A calculation coordinate system that is a rectangular coordinate system with the abscissa representing the propulsive force F of the vehicle 1 and the ordinate representing the acceleration Q of the vehicle 1 as shown in FIG. 2 will be considered. A combination of acceleration Q and propulsive force F at a certain timing during travel of the vehicle 1 will be referred to as “individual data set DU.” It is herein assumed that a plurality of individual data sets DU has been plotted on the calculation coordinate system as shown by the black circles in FIG. 2. According to the relationship of Expression (2), the individual data sets DU are theoretically plotted on a straight line whose slope is the reciprocal of the weight M of the vehicle 1. When calculating the weight W of the vehicle 1, the CPU 20 calculates the slope of a regression line L for the plot of the individual data sets DU by using these points. The CPU 20 calculates the reciprocal of this slope as the weight M of the vehicle 1. The regression line L is a straight line obtained by applying the least squares method to the individual data sets DU.

### Various Types of Information Related to Weight Calculation Process

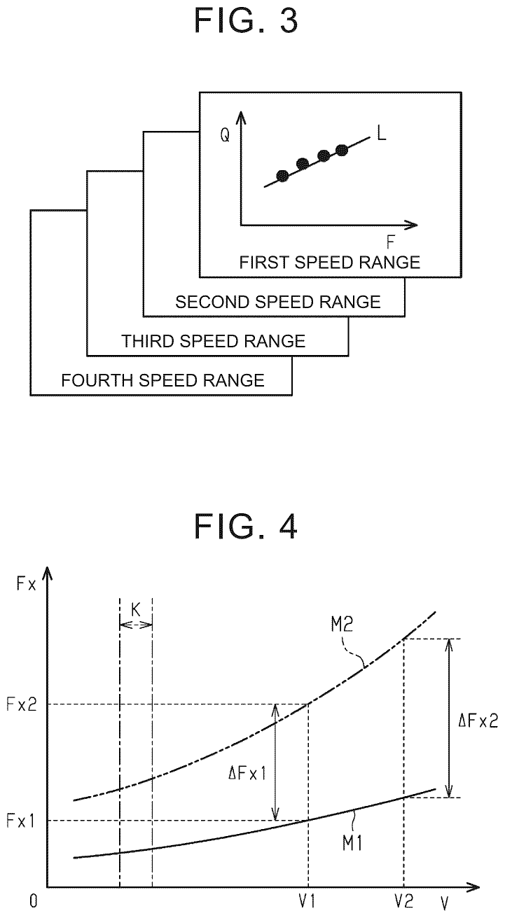

The CPU 20 can perform a weight calculation process for calculating the weight M of the vehicle 1. In order for the CPU 20 to perform the weight calculation process, the first memory 21 stores a plurality of specific speed ranges in advance. The specific speed ranges are obtained by dividing possible travel speeds of the vehicle 1 into a plurality of speed ranges. The specific speed ranges will be described later. As shown in FIG. 3, in the weight calculation process, the CPU 20 calculates the regression line L for each of the specific speed ranges. The CPU 20 thus calculates the weight M of the vehicle 1 for each specific speed range. Although FIG. 3 representatively shows four of the specific speed ranges, the number of specific speed ranges is not limited to four.

The first memory 21 stores a weight list for managing the weights M of the vehicle 1 in association with the specific speed ranges. The weight list is a table that associates the specific speed ranges with provisional weights MA. Each provisional weight MA is the weight M of the vehicle 1 in a corresponding one of the specific speed ranges. This weight list describes a final weight MB in addition to the provisional weight MA for each specific speed range. The final weight MB is the weight M of the vehicle 1 for the entire range of the vehicle speed V. The CPU 20 reflects this final weight MB in the control of the actuator units 70. The CPU 20 updates the provisional weights MA and final weight MB in the weight list as needed through the weight calculation process. When either of the following two predetermined reset conditions is satisfied, the CPU 20 resets the provisional weights MA and final weight MB in the weight list to a standard weight. The standard weight is the weight M of the vehicle 1 determined in advance according to the standard of the vehicle 1. This standard weight includes a certain weight value in view of the load. One of the reset conditions is that the start switch 67 of the vehicle 1 is switched from off to on. The other reset condition is that any door of the vehicle 1 is switched from the open state to the closed state while the start switch 67 of the vehicle 1 is on.

The first memory 21 stores an acquired data list for each specific speed range as information to be used in the weight calculation process. The acquired data list for one specific speed range is a table in which a plurality of acquired data groups is arranged in order. One acquired data group is a set of the following four pieces of information. The first information in the acquired data group is the acquisition date and time of the second to fourth information described below. The second information is the acceleration Q of the vehicle 1. The third information is an estimated driving force Fd1 that is an estimated value of an actual driving force Fd of the vehicle 1. The fourth information is a tentative resistance FxA described later. The CPU 20 adds acquired data groups to the acquired data list for each specific speed range as needed through the weight calculation process. When either of the above two reset conditions is satisfied, the CPU 20 erases the contents of the acquired data list for each specific speed range at that point.

### Specific Speed Range

As described above, the running resistance Fx is basically proportional to the square of the vehicle speed V. This relationship between the running resistance Fx and the vehicle speed V can change depending on the weight M of the vehicle 1. The relationship between the running resistance Fx and the vehicle speed V will be compared between when the vehicle 1 has a first weight M1 as shown by the continuous line in FIG. 4 and when the vehicle 1 has a second weight M2 as shown by the long dashed double-short dashed line in FIG. 4. The second weight M2 is greater than the first weight M1. The running resistance Fx shown in FIG. 4 is the proper running resistance Fx according to the weight M of the vehicle 1 as determined through experiments or simulations. For example, as shown in FIG. 4, when the vehicle speed V is the first vehicle speed V1, a second running resistance Fx2 is greater than a first running resistance FxL. The first running resistance Fx1 is the running resistance Fx when the vehicle 1 has the first weight M1, and the second running resistance Fx2 is the running resistance Fx when the vehicle 1 has the second weight M2. This tendency of the difference in running resistance Fx also applies to other vehicle speeds V. That is, for other vehicle speeds V as well, the running resistance Fx is greater when the vehicle 1 has the second weight M2 than when the vehicle 1 has the first weight M1. In the example of FIG. 4, the higher the vehicle speed V, the greater the difference between the running resistance Fx corresponding to the first weight M1 and the running resistance Fx corresponding to the second weight M2.

The first memory 21 stores in advance a resistance relational expression representing the relationship between the running resistance Fx and the vehicle speed V. This resistance relational expression is for the case where the weight M of the vehicle 1 is a certain specific value. In the present embodiment, the specific value is the first weight M1. In the present embodiment, the running resistances Fx corresponding to various weights M are calculated using this one resistance relational expression. Hereinafter, the running resistance Fx calculated using the resistance relational expression will be referred to as “tentative resistance FxA.” As described above, even when the vehicle speed V is the same, the proper running resistance Fx is different depending on the weight M of the vehicle 1. Therefore, there is the following problem when calculating the tentative resistances FxA corresponding to various weights M of the vehicle 1 using only one resistance relational expression. When the weight M of the vehicle 1 is other than the first weight M1, the tentative resistance FxA determined from the resistance relational expression has a value different from the proper running resistance Fx according to the weight M of the vehicle 1. An example in which the vehicle speed V is the first vehicle speed V1 in FIG. 4 will be considered. In this case, the proper running resistance Fx when the vehicle 1 has the second weight M2 is the second running resistance Fx2. However, the tentative resistance FxA determined from the resistance relational expression when the vehicle speed V is the first vehicle speed V1 is the first running resistance Fx1 that corresponds to the first vehicle speed V1 when the vehicle 1 has the first weight M1. The first running resistance Fx1 is smaller than the second running resistance Fx2. That is, as shown by the range ΔFx1 indicated by the continuous double arrow in FIG. 4, the tentative resistance FxA determined from the resistance relational expression includes an error ΔFx with respect to the proper running resistance Fx.

Each of the specific speed ranges is determined in relation to such an error ΔFx. This will be described below. As shown in FIG. 4, for the case where the vehicle 1 has the second weight M2, the error ΔFx when the vehicle speed V is the first vehicle speed V1 will be referred to as “first error ΔFx1,” and the error ΔFx when the vehicle speed V is the second weight M2 will be referred to as “second error ΔFx2.” When the first vehicle speed V1 and the second vehicle speed V2 are approximately the same, the first error ΔFx1 and the second error ΔFx2 are approximately the same. On the other hand, when the first vehicle speed V1 and the second vehicle speed V2 are significantly different from each other, the first error ΔFx1 and the second error ΔFx2 are significantly different from each other. The difference between the first error ΔFx1 and the second error ΔFx2 increases as the difference between the first vehicle speed V1 and the second vehicle speed V2 increases. Based on such a relationship between the vehicle speed V and the error ΔFx, each specific speed range is set as follows. One specific speed range K is defined as a range of the vehicle speed V in which the error ΔFx between the proper running resistance Fx and the tentative resistance FxA determined from the resistance relational expression can be considered to be approximately the same. The specific speed ranges will be described in more detail in the section “Functions of Embodiment” below. FIG. 4 shows an example of one specific speed range K.

### Details of Weight Calculation Process

The CPU 20 repeatedly performs the weight calculation process while the start switch 67 of the vehicle 1 is on. As a separate process from the weight calculation process, the CPU 20 repeatedly calculates a required driving force Fd2 while the start switch 67 is on. The required driving force Fd2 is a required value of the driving force Fd for the vehicle 1. The CPU 20 calculates the required driving force Fd2 based on the latest vehicle speed V and the accelerator operation amount C. At this time, the CPU 20 uses, for example, a map representing the relationship among the vehicle speed V, the accelerator operation amount C, and the required driving force Fd2. The CPU 20 calculating the required driving force Fd2 of the vehicle 1 is equivalent to the CPU 20 acquiring the required driving force Fd2 of the vehicle 1. The CPU 20 controls the actuator units 70 so that the actual driving force Fd of the vehicle 1 becomes equal to the required driving force Fd2.

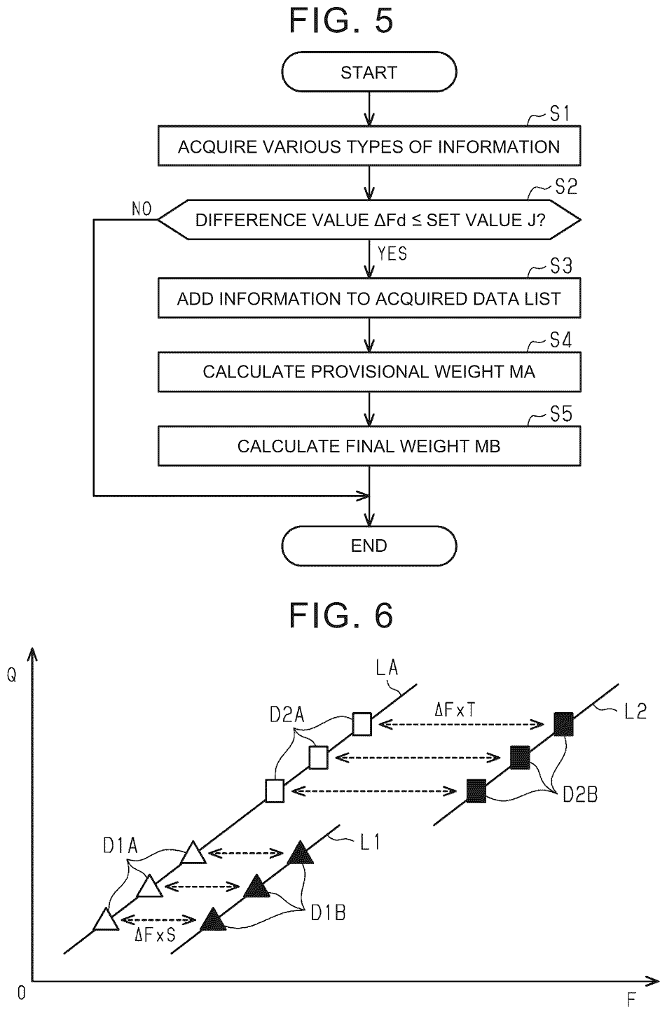

As shown in FIG. 5, when the weight calculation process is started, the CPU 20 first performs step S1. In step S1, the CPU 20 acquires various types of information necessary to calculate the provisional weight MA for each specific speed range. The CPU 20 first acquires the latest value of the required driving force Fd2 that is calculated in the separate process. The CPU 20 also acquires the latest information from each sensor mounted on the vehicle 1. The information the CPU 20 acquires from each sensor is the acceleration Q of the vehicle 1, the vehicle speed V, the intake air amount Y, and the rotational position N of the crankshaft. Once the CPU 20 acquires these pieces of information, it calculates the estimated driving force Fd1. When calculating the estimated driving force Fd1, the CPU 20 first calculates the rotational speed of the crankshaft based on the rotational position N of the crankshaft. The CPU 20 then calculates the torque of the internal combustion engine based on the rotational speed of the crankshaft and the intake air amount Y. When calculating the torque of the internal combustion engine, the CPU 20 uses, for example, a map representing the relationship among the rotational speed of the crankshaft, the intake air amount Y, and the torque of the internal combustion engine. After calculating the torque of the internal combustion engine, the CPU 20 calculates the estimated driving force Fd1 by multiplying the torque by each necessary variable. The necessary variables include the gear ratio of the transmission mechanism based on the current speed ratio, and the reciprocal of the wheel diameter. As described above, the CPU 20 calculates the estimated driving force Fd1 based on the information obtained from the air flow meter 64 and the crank sensor 65. The CPU 20 calculating the estimated driving force Fd1 is equivalent to the CPU 20 acquiring the estimated driving force Fd1. After calculating the estimated driving force Fd1, the CPU 20 calculates the tentative resistance FxA. At this time, the CPU 20 uses the resistance relational expression. Specifically, the CPU 20 calculates the tentative resistance FxA by applying the latest vehicle speed V acquired as described above to the resistance relational expression. The CPU 20 calculating the tentative resistance FxA is equivalent to the CPU 20 acquiring the tentative resistance FxA. The CPU 20 temporarily stores the various types of information acquired in the above step in the second memory 22. The process then proceeds to step S2.

In step S2, the CPU 20 determines whether a difference value ΔFd is equal to or less than a set value J. The difference value ΔFd is the absolute value of the difference between the estimated driving force Fd1 acquired in step S1 and the required driving force Fd2. The air flow meter 64 and the crank sensor 65 will be herein generally referred to as “engine sensors.” When these engine sensors are operating normally, the detected values from these engine sensors are basically close to the actual values of their detection targets. In this case, the estimated driving force Fd1 has a value close to the required driving force Fd2. Therefore, the difference value ΔFd is small. On the other hand, when at least one of the two engine sensors has, for example, a temporary abnormality, the detected value from the abnormal sensor may deviate significantly from the actual value of the detection target. In this case, the estimated driving force Fd1 deviates significantly from the required driving force Fd2. Therefore, the difference value ΔFd is large. The set value J is determined in advance through, for example, experiments or simulations as a threshold value for distinguishing between when both of the two engine sensors are normal and when at least one of the two engine sensors is abnormal. It can also be said that the set value J is the maximum possible value of the difference value ΔFd when both of the two engine sensors are normal. The set value J is, for example, a fixed value. The set value J may be determined in advance so that it can be variably set according to, for example, the required driving force Fd2. When the difference value ΔFd is greater than the set value J (step S2: NO), the series of steps of the weight calculation process ends. The process then returns to step S1. On the other hand, when the difference value ΔFd is equal to or less than the set value J (step S2: YES), the process proceeds to step S3. Through step S2, the CPU 20 narrows down the estimated driving forces Fd1 for calculating the provisional weight MA to only target driving forces that are the estimated driving forces Fd1 whose difference value ΔFd is equal to or less than the set value J. As a result, the CPU 20 calculates the provisional weight MA based on the combinations of the target driving force and the acceleration Q of the vehicle 1 in step S4 described later.

In step S3, the CPU 20 adds new information to the acquired data list stored in the first memory 21. Specifically, the CPU 20 refers to the vehicle speed V acquired in step S1. The CPU 20 then determines within which of the specific speed ranges the referenced vehicle speed V falls. Subsequently, the CPU 20 performs the following on the acquired data list for this specified specific speed range out of the acquired data lists stored in the first memory 21. That is, the CPU 20 adds the current date and time, the acceleration Q acquired in step S1, the estimated driving force Fd1, and the tentative resistance FxA to this acquired data list. By this step, the CPU 20 stores combinations of the acceleration Q of the vehicle 1 acquired in step S1 and the estimated driving force Fd1 in the first memory 21 in a distinguishable manner for each specific speed range. Once the new information is added to the acquired data list, the CPU 20 determines the subsequent process flow according to whether a sample condition is satisfied. The sample condition is that, regarding the acquired data list to which information has been added in step S3, the number of acquired data groups in the acquired data list has reached a predetermined value. The predetermined value is determined in advance as the number of acquired data groups that is statistically large enough to calculate the regression line L. When the sample condition is not satisfied, the series of steps of the weight calculation process ends. In this case, the process returns to step S1. On the other hand, when the sample condition is satisfied, the process proceeds to step S4. Hereinafter, the specific speed range specified in step S3 will be referred to as “update speed range.”

In step S4, the CPU 20 calculates the provisional weight MA for the update speed range. At this time, the CPU 20 uses information on all the sets of the acceleration Q and the estimated driving force Fd1 included in the acquired data list for the update speed range. That is, the CPU 20 calculates the provisional weight MA based on all the combinations of the acceleration Q and the estimated driving force Fd1 acquired after the acquired data list was reset. When calculating the provisional weight MA, the CPU 20 first refers to the estimated driving force Fd1 and tentative resistance FxA for each date and time out of the information included in the acquired data list for the update speed range. The CPU 20 then converts the estimated driving force Fd1 for each date and time to a propulsive force F using the above Expression (3). That is, the CPU 20 calculates the propulsive force F by subtracting the tentative resistance FxA from the estimated driving force Fd1. Thereafter, the CPU 20 plots the individual data set DU, namely a set of the acceleration Q and the propulsive force F for each date and time, on a calculation coordinate system as shown by the black circles in FIG. 2. The CPU 20 then divides the calculation coordinate system into a plurality of areas R. FIG. 2 shows an example in which the calculation coordinate system is divided into the areas R for each fixed range of the propulsive force F. The CPU 20 performs the following for each area R. The CPU 20 calculates the average value of the accelerations Q and the average value of the propulsive forces F for a plurality of sets of acceleration Q and propulsive force F included in one area R. The CPU 20 then plots average data sets DH, namely sets of the average values of the acceleration Q and the average values of the propulsive force F, on the calculation coordinate system. The CPU 20 plots one average data set DH for each area R. When calculating the average value of the accelerations Q, the CPU 20 weights the accelerations Q according to the date and time each acceleration Q was acquired. Specifically, the CPU 20 calculates the average value of the accelerations Q such that the more recent the date and time the acceleration Q was acquired, the more heavily the acceleration Q is weighted. For the average value of the propulsive forces F as well, the CPU 20 similarly considers the date and time each propulsive force F was acquired. After plotting the average data set DH for each area R, the CPU 20 determines a regression line L for these average data sets DH. At this time, the CPU 20 uses a known relational expression for calculating the slope and intercepts of the regression line L. This relational expression is stored in advance in the first memory 21. After calculating the slope and intercepts of the regression line L, the CPU 20 calculates the reciprocal of the slope as a provisional weight MA. The CPU 20 then updates the provisional weight MA for the update speed range in the weight list with the new value. That is, the CPU 20 overwrites the previously stored provisional weight MA for the update speed range with the new provisional weight MA. As shown in FIG. 5, after the CPU 20 updates the weight list, the process proceeds to step S5. Regarding step S4, the CPU 20 calculates the provisional weight MA based on combinations of the propulsive force F and the acceleration Q. The propulsive force F is a value obtained from the estimated driving force Fd1. Therefore, the CPU 20 calculates the provisional weight MA based on combinations of the estimated driving force Fd1 and the acceleration Q.

In step S5, the CPU 20 calculates the final weight MB that is a final weight M. Specifically, the CPU 20 calculates the average value of the provisional weights MA for the specific speed ranges in the weight list as the final weight MB. After calculating the final weight MB, the CPU 20 updates the final weight MB in the weight list with the new value. Then, the series of steps of the weight calculation process ends. Thereafter, the process returns to step S1.

### Functions of Embodiment

In the present embodiment, as shown in FIG. 3, the slope of the regression line L and the provisional weight MA are calculated for each specific speed range. The advantages of this will be described.

Problems with calculating the weight M of the vehicle 1 for the entire range of the vehicle speed V rather than for each specific speed range will be described. In the present embodiment, the running resistance Fx that is used to calculate the propulsive force F of the vehicle 1 is calculated using one resistance relational expression. As described above, when the vehicle 1 does not have the first weight M1, there is an error ΔFx between the tentative resistance FxA that is the running resistance Fx calculated from the resistance relational expression and the proper running resistance Fx. In connection with this, the following problems will occur when the regression line L is obtained by plotting the sets of acceleration Q and propulsive force F for all the vehicle speeds V on the same calculation coordinate system.

It is herein assumed that the vehicle 1 has the second weight M2. An example will be considered in which sets of acceleration Q and propulsive force F for two specific speed ranges, a first speed range and a second speed range, are plotted on one calculation coordinate system as shown in FIG. 6. First, it is assumed that a plurality of sets D1A of propulsive force F reflecting the proper running resistance Fx and acceleration Q for the first speed range is plotted as shown by the white triangles in FIG. 6. It is also assumed that a plurality of sets D2A of propulsive force F reflecting the proper running resistance Fx and acceleration Q for the second speed range is plotted as shown by the white rectangles in FIG. 6. In this case, the sets D1A for the first speed range and the sets D2A for the second speed range are theoretically on the same regression line LA. Next, it is assumed that a plurality of sets D1B of propulsive force F reflecting the tentative resistance FxA and acceleration Q for the first speed range is plotted as shown by the black triangles in FIG. 6. It is also assumed that a plurality of sets D2B of propulsive force F reflecting the tentative resistance FxA and acceleration Q for the second speed range is plotted as shown by the black rectangles in FIG. 6. In this case, the distribution of the sets D1B for the first speed range and the distribution of the sets D2B for the second speed range have different tendencies from each other due to the error ΔFx. That is, since a first value ΔFxS that is the error ΔFx for the first speed range and a second value ΔFxT that is the error ΔFx for the second speed range are different, the sets D1B for the first speed range and the sets D2B for the second speed range are not on the same regression line. Therefore, it is not possible to calculate a statistically significant regression line from a plot combining all of these.

On the other hand, within the same specific speed range such as the first speed range, the error ΔFx between the proper running resistance Fx and the tentative resistance FxA is always approximately the same value, namely the first value ΔFxS. Therefore, within the first speed range, the correlation that is present between the proper propulsive force F and the acceleration Q is maintained for the sets D1B of propulsive force F reflecting the tentative resistance FxA and acceleration Q, as shown by the black triangles in FIG. 6. The regression line L1 characterizing this correlation has the same slope as the regression line LA corresponding to the proper propulsive force F, and is different only in intercepts from the regression line LA. The same applies to a regression line L2 for the second speed range. The specific speed ranges will be described in detail again based on the above. Each specific speed range is determined in advance through, for example, experiments or simulations so as to satisfy the following point. Namely, in one specific speed range, the correlation between the proper propulsive force F and the acceleration Q is maintained between the propulsive force F reflecting the tentative resistance FxA and the acceleration Q.

For the above reasons, when the slopes of the regression lines L1, L2 are calculated individually for each specific speed range, the same slope as the proper regression line LA can be obtained even if the tentative resistance FxA and therefore the propulsive force F include an error ΔFx with respect to their proper values. As a result, an accurate provisional weight MA can be obtained for each specific speed range.

### Effects of Embodiment

(1) As described in the section “Functions of Embodiment,” in the present embodiment, the provisional weight MA can be accurately calculated by individually calculating the provisional weight MA for each specific speed range.
(2) Of the estimated driving force Fd1 and the required driving force Fd2, the estimated driving force Fd1 that is likely to be close to the actual driving force Fd is preferably used as the driving force Fd of the vehicle 1 that is used to calculate the provisional weight MA. However, the estimated driving force Fd1 may also deviate from the actual driving force Fd depending on the state of the sensors. Therefore, the provisional weight MA can be accurately calculated by reflecting the estimated driving force Fd1 in calculation of the provisional weight MA only when the estimated driving force Fd1 is close to the required driving force Fd2, as in the present embodiment.
(3) In the present embodiment, the average value of the provisional weights MA for the specific speed ranges is calculated as the final weight MB. In this case, errors that may be included in the provisional weights MA for the specific speed ranges can be cancelled out. Therefore, the final weight MB can be obtained as a more accurate weight M of the vehicle 1.

### Modifications

The above embodiment can be modified as follows. The above embodiment and the following modifications can be combined as long as no technical contradiction arises.

It is not essential to calculate the slope of the regression line L by using the average data set DH for each area R. The slope of the regression line L may be calculated using the individual data sets DU.

When calculating the propulsive force F that is one element of the individual data set DU, the tentative resistance FxA may be subtracted from the required driving force Fd2. That is, the provisional weight MA may be calculated based on the required driving force Fd2 instead of the estimated driving force Fd1. In this case, the required driving force Fd2 need only be included as one of the contents of the acquired data list.

A combination of the driving force Fd itself of the vehicle 1, instead of the propulsive force F, and the acceleration Q of the vehicle 1 may be used when calculating the slope of the regression line L. That is, the combination of the driving force Fd and the acceleration Q may be handled as an individual data set DU. As described in the section “Functions of Embodiment,” when calculating the slope of the regression line L for each specific speed range, the slope of the regression line L can be accurately calculated as long as there is a correlation between the two parameters of the individual data set DU for each specific speed range. Therefore, even when the combination of the driving force Fd and the acceleration Q is handled as an individual data set DU, the slope of the regression line L can be accurately calculated as long as there is a correlation between the driving force Fd and the acceleration Q. In other words, each specific speed range need only be set so that there is a correlation between the driving force Fd and the acceleration Q.

When calculating the final weight MB by obtaining the average value of the provisional weights MA for the specific speed ranges, the provisional weights MA may be weighted according to the specific speed range. When the vehicle speed V is high, the calculation accuracy of the provisional weight MA can be higher than when the vehicle speed V is low. Considering this point, it is conceivable to weight the provisional weights MA so that the higher the vehicle speed V of the specific speed range, the more heavily the provisional weight MA is weighted.

It is not essential to calculate the average value of the provisional weights MA for the specific speed ranges in order to obtain the final weight MB. For example, the provisional weight MA for the update speed range may be used as the final weight MB. —The content and number of reset conditions are not limited to the example of the above embodiment. The reset conditions may be appropriately set so that the number of samples necessary to calculate the weight M of the vehicle 1 can be obtained.

The content of the weight calculation process is not limited to the example of the above embodiment. The weight calculation process need only be configured to calculate the weight M of the vehicle 1 based on a plurality of combinations of the acceleration Q and the driving force Fd of the vehicle 1 for each specific speed range.

Applications in which the weight M of the vehicle 1 is used are not limited to the example of the above embodiment. The weight M may be used as necessary. An information processing device that functions as the weight calculation device is not limited to the motion manager. Any information processing device can function as the weight calculation device as long as it includes a calculation unit and a storage unit that can implement the same weight calculation method as that of the above embodiment.

The overall configuration of the vehicle 1 is not limited to the example of the above embodiment. For example, the driving source for the vehicle 1 may be an electric motor instead of or in addition to the internal combustion engine. When the driving source for the vehicle 1 is an electric motor, a current sensor that detects a current flowing through the electric motor need only be mounted on the vehicle 1. The torque of the electric motor and the estimated driving force Fd1 can be calculated based on the detected value from this sensor.

What is claimed is:

1. A weight calculation device, comprising:
one or more processors; and
one or more memories, wherein
the one or more memories are configured to:
store a plurality of specific speed ranges in advance, the specific speed ranges being obtained by dividing a travel speed of a vehicle into a plurality of speed ranges, and
the one or more processors are configured to:
acquire the travel speed of the vehicle, an acceleration of the vehicle, and a driving force of the vehicle while the vehicle is traveling,
store a combination of the acquired acceleration of the vehicle and the acquired driving force of the vehicle in the one or more memories in a distinguishable manner for each of the specific speed ranges, and
calculate a weight of the vehicle for each of the specific speed ranges based on a plurality of the combinations of the acquired acceleration of the vehicle and the acquired driving force of the vehicle.

2. The weight calculation device according to claim 1, wherein the one or more processors are configured to:
acquire a required driving force that is a required value of the driving force for the vehicle,
acquire an estimated driving force that is an estimated value of an actual driving force of the vehicle, based on information from a sensor mounted on the vehicle, and
calculate the weight of the vehicle based on a combination of a target driving force and the acceleration of the vehicle, the target driving force being the estimated driving force whose difference from the required driving force is equal to or less than a predetermined set value.

3. The weight calculation device according to claim 1, wherein the weight calculation device is configured to calculate, as a final weight of the vehicle, an average value of weights of the vehicle calculated for two or more of the specific speed ranges.

4. The weight calculation device according to claim 1, wherein:
the weight calculation device is configured to calculate, as a final weight of the vehicle, a weighted average value of weights of the vehicle calculated for two or more of the specific speed ranges; and
when calculating the weighted average value, a weight of the vehicle calculated for a specific speed range in which a vehicle speed is high is weighted more heavily than a weight of the vehicle calculated for a specific speed range in which the vehicle speed is low.
